(19) United States
(12) Patent Application Publication
(10) Pub. No.: US 2017/0228793 A1
(43) Pub. Date: Aug. 10, 2017

(54) METHOD AND APPARATUS FOR MEDIA PAYMENTS

(71) Applicants: David BIENSTOCK, Sherman Oaks, CA (US); Adam STOLL, Sherman Oaks, CA (US); Richard OTRUBA, Atlanta, GA (US); Wade ECKMAN, Atlanta, GA (US)

(72) Inventors: David BIENSTOCK, Sherman Oaks, CA (US); Adam STOLL, Sherman Oaks, CA (US); Richard OTRUBA, Atlanta, GA (US); Wade ECKMAN, Atlanta, GA (US)

(21) Appl. No.: 15/429,119

(22) Filed: Feb. 9, 2017

Related U.S. Application Data
(60) Provisional application No. 62/293,297, filed on Feb. 9, 2016.

(51) Int. Cl. G06Q 30/02

(52) U.S. Cl. CPC G06Q 30/0273; G06Q 30/0251

(57) ABSTRACT

The system provides a method and apparatus for processing payments for media buys that eliminates the complexity and time delay of current media buy payment approaches. The system enables media buyers to facilitate electronic payment and payment remittance to media providers such as stations and station groups. The system reduces the manual activities and challenges around ad buys for media providers as well as the media buyers. Through the closed loop network of the system, media providers can receive media buy payments electronically with real-time notifications throughout the payment cycle.

### CLAIM OF BENEFIT TO PRIOR APPLICATIONS

This patent application claims priority to U.S. Provisional Patent Application No. 62/293,297 Filed on Feb. 9, 2016, which is incorporated by reference herein in its entirety.

### BACKGROUND OF THE SYSTEM

A “media buy” is a purchase of an advertising unit from a media provider. The media provider may be a television station, network, newspaper, magazine, internet site, mobile carrier, or any other entity, medium, or location that can present an advertisement to potential customers or recipients. A media buyer negotiates a targeted audience, platform, and ratings value (media inventory) and purchases the inventory at an agreed upon price. Often the media buyer acts as an intermediary between an advertiser and the media provider. In some cases, the advertiser itself may be a media buyer.

The current system for finalizing the financial portion of a media buy is to have the advertiser pay a media buyer, by check or by credit card, and for the media buyer to pay the media provider in advance of the running of the advertisement. Often the media buyer will negotiate a media buy of ad units from a plurality of media providers. The media buyer will then invoice the client (advertiser). The client will send separate checks for each media provider. In some cases, the client will send multiple checks to a single media provider if the billing is on a time period basis (e.g. daily, weekly, monthly).

Due to the ephemeral nature of an advertisement, the media provider typically requires payment prior to the running of the ad unit. This requires that the media buyer negotiate the scheduled ad units and prices, invoice the advertiser, and then pay the media provider some fixed time in advance of the running of the ad unit. When physical checks are used, such a time period must include the necessary time for a check to be prepared, delivered, and to clear.

If credit cards are used, there must be separate transactions for every media provider.

The current system is complex and requires significant lead time in planning and finalizing an advertising campaign. Because of tight schedules, confirmation of payment is often not available by the time a purchased ad unit is to run. This leads to lost aired inventory because the media provider does not run the ad unit.

### SUMMARY

The following presents a simplified summary of one or more aspects of the present disclosure in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect, according to an example, the system provides a method and apparatus for processing payments for media buys that eliminates the complexity and time delay of current media buy payment approaches. The system enables media buyers to facilitate electronic payment and payment remittance to media providers such as stations and station groups. The system reduces the manual activities and challenges around ad buys for media providers as well as the media buyers.

Through the closed loop network of the system, media providers can receive media buy payments electronically with real-time notifications throughout the payment cycle.

According to an example, the system provides a method of scheduling and paying for ad units comprising: using a processor implemented system. The method includes scheduling a plurality of ad units associated with a media campaign, wherein the ad units are scheduled by a Media Buyer using an ordering system that provides ad inventory of a plurality of Media Providers. The method includes, for each ad unit, scheduling an air time for the ad unit and a deadline to pay a cost required to release the ad unit. The method includes directing the Media Buyer to deposit into a system account associated with the processor implemented system the cost of each scheduled ad unit. The method includes automatically transferring the cost for the ad unit when the deadline has occurred from the system account to a Media Provider account associated with the Media Provider providing the ad unit. The method includes notifying a Media Provider that provides the ad unit that the cost has been transferred to the Media Provider account. The method includes automatically providing an instruction to the Media Provider of the ad unit to release the ad unit for airing.

According to an example, the method includes the ordering system coupled to accounting and scheduling systems of a plurality of Media Providers. The method includes the ordering system normalizing data from each Media Provider to present a consistent interface to the Media Buyer.

According to an example, The method includes the funds being transferred from the system account to the Media Provider account by wire transfer. The method includes the funds being transferred from the system account to the Media Provider account by electronic deposit. The method includes a notification automatically generated to the Media Buyer and the Media Provider when the funds are transferred. The method includes accounting information about each transfer automatically provided to the Media Buyer and the Media Provider.

According to an example, the method includes the ordering system comprising an Ad Buyer Interface Generator to generate an interface showing available ad unit inventory, an Ad Inventory Processor coupled to the Ad Buyer Interface Generator and to a Media Provider Inventory Database to store available Ad Inventory to be scheduled in the system, and an Ad Buyer Scheduler and Accounting System to store each ad unit selected by the Ad Buyer.

### BRIEF DESCRIPTION OF THE DRAWINGS

FIG. 1 illustrates an embodiment of the system.

FIG. 2 is a flow diagram illustrating the operation of the system in one embodiment.

FIG. 3 is a flow diagram illustrating the initiation of aggregate fund transfer in an embodiment of the system.

FIG. 4 is an example of a Media Buyer portal in an embodiment of the system.

FIG. 5 is an example of the portal of FIG. 4 with a funds management tab active.

FIG. 6 is a block diagram of an embodiment of the Ordering System of FIG. 1.

FIG. 7 is an example computer system of an embodiment of the system.

### DETAILED DESCRIPTION OF THE SYSTEM

The budget for advertising using one or more forms of media is called the “media spend” (or “media budget”). An ad campaign may have a media spend that is the total available for all media that will be used in the campaign. This media spend is typically allocated to different forms of media (e.g. digital, television, radio, print, and the like) and within each category, to one or more media providers. For example, the portion of the media spend allocated to television may be used in one or more markets on one or more stations, networks, programs, and the like.

An advertiser uses ratings information to determine where and when to spend its media budget on media buys. For example, if an advertiser wants to advertise on television, the advertiser will rely in part on the ratings of a particular program, such as those ratings provided by companies such as the Nielsen company.

“In advertising, a Gross rating point (GRP) is a measure of the size of an advertising campaign by a specific medium or schedule. It does not measure the size of the audience reached, but rather GRPs quantify impressions as a percentage of the target population, and this percentage may thus be greater than, or in fact much greater than, 100. Target rating points are sometimes used to express the same idea.

Consider a program that has a rating of 7, and an ad is placed on 5 episodes of that program. The GRP for that ad placement is 35. For a campaign on multiple programs, the GRP may be in the hundreds or thousands. When an advertiser plans a campaign, it can begin with a target of the GRPs that the advertiser wants to achieve. From there, the advertiser can pick and choose programs on which to advertise to achieve the desired GRP total. The campaign is typically defined by a time period (e.g. one or two weeks) in which to achieve the GRP target.

Because each GRP has a cost associated with it, and because the advertiser has a media spend budget limit, the advertiser must match up the goal of achieving the GRP target with the ability to buy the necessary ad time within the media spend budget. For example, because of its extremely high ratings, the Super Bowl could provide a high number of GRPs but the cost of advertising on the Super Bowl may exceed the media spend available. Therefore it is necessary to find lower priced alternatives to achieve the GRP target.

One particular kind of advertising is political advertising. Political advertising creates an additional metric that needs to be satisfied in planning an advertising campaign, namely the political demographics associated with the audience of a television program. This information may be available from rating companies such as Nielsen, Rentrak, and others, and is a filter on standard ratings that must be considered in calculating GRP for a political advertising campaign and corresponding media spend.

The system will be described in connection with a political advertising campaign, but it will be understood that the invention may be practiced with any type of advertising without departing from the scope and spirit of the system.

Typically an advertiser will rely on a media buyer to determine on which media providers to purchase ad time and when the ads will run. The advertiser provides a budget and a proposal for an ad campaign to a media buyer. The media buyer formulates a media plan that enumerates the various media providers that will be utilized in the ad campaign. The media buyer then communicates with the media providers and negotiates for time and shows on which to advertise, along with a negotiated rate.

Once negotiations are complete, the ad unit is offered from the media provider to the media buyer pending confirmation of payment. The media provider (e.g. television station, radio station, newspaper, digital provider, and the like) will typically require payment in advance before running the proffered ad unit. For a large advertising campaign, the numbers of ad units to track is quite large, and the administrative effort to track the various media buys and to make sure that payment is made in advance is complex.

In the prior art, the use of checks and individual charges required long lead times and complex monitoring and accounting to make sure that payments are confirmed by the media provider deadline so that the ads would run as desired. Although credit card transactions can be used, shortening lead times, there are still potential pitfalls and disadvantages to the media provider. For instance, credit card payments can be reversed, adding another level of uncertainty to prior art transactions.

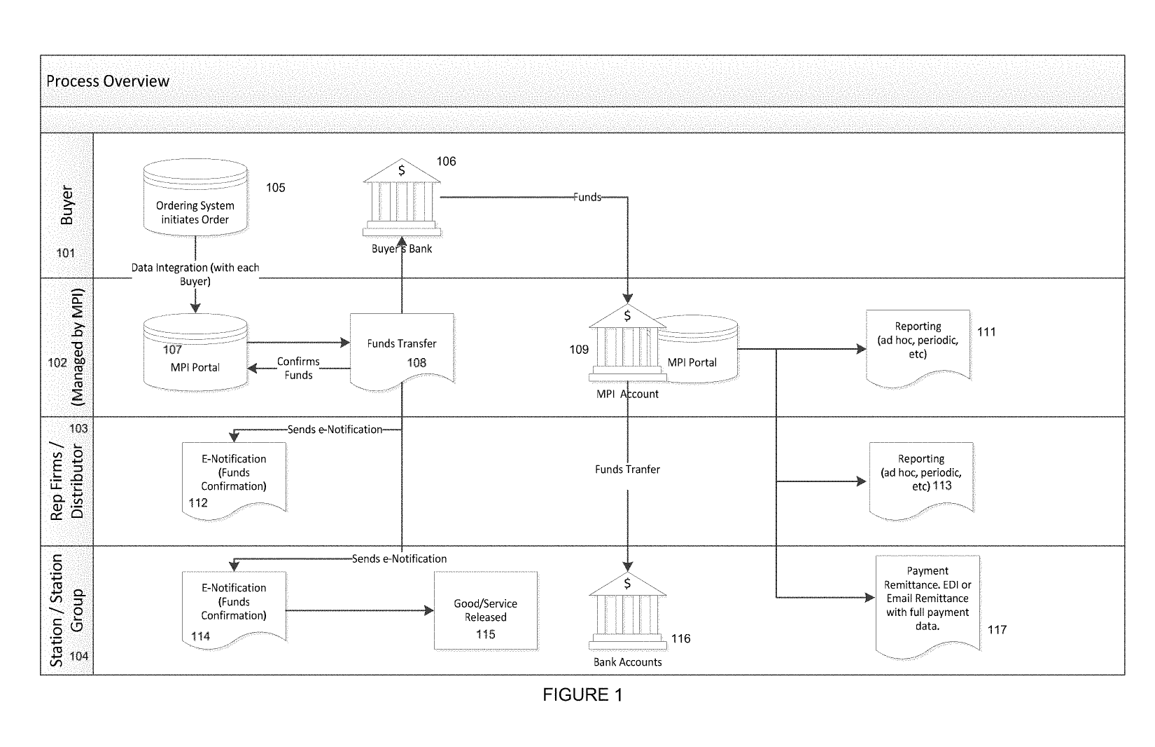

The present system replaces the prior art system of checks and multiple credit card transactions using an improved payment and confirmation system. The operation of the system in one embodiment is illustrated in FIG. 1. The system contemplates an Media Buyer 101, Payment System 102, Distributor 103, and Media Provider 104.

The Media Buyer 101 is a media buyer who uses the media spend of an advertiser to negotiate and purchase ad units from one or more media sources. The Media Buyer 101 will purchase ad units to satisfy the GRP goals of the campaign.

The Media Provider 104is a seller of ad units for a particular media (e.g. TV, radio, print, digital, mobile, etc.). A media provider may be a single station, a network, a syndicate, an aggregator, or the like. In a campaign, there are typically a plurality of Media Providers 104 that sell ad units to the Media Buyer 101.

The systems provides payment processing between the Media Buyer 101 and the Media Provider 104 via Payment System 102 and Distributor 103.

The system provides an Ordering System 105 for use by the Media Buyer 101 to communicate with the Payment System 102. The ordering system 105 allows the buyer to transmit to the Payment System the ad time to be ordered, the Media Provider 104 providing the ad time and ad units, and the negotiated cost for the ad time, along with relevant deadlines agreed to by the Media Provider 104 and the Buyer 101. This system implements accounting integration between the Buyer 101 and Payment System 102.

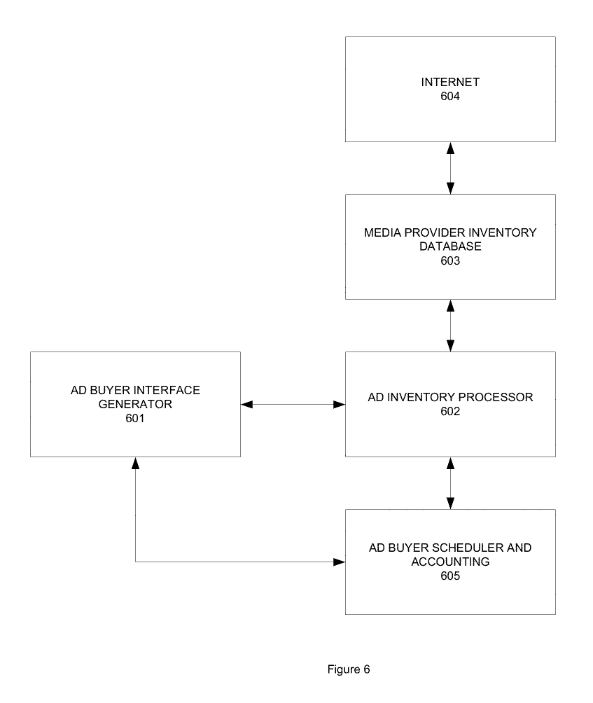

The Ordering System 105 provides a new level of integration between the Media Provider 104 and Media Buyer 101. In the prior art, the Media Buyer 101 would need to communicate individually with each Media Provider 104. In the present system, Media Providers 104 elect to become partners and act as a clearinghouse for ad purchases. The operation of the Ordering System 105 is described more fully in connection with FIG. 6.

FIG. 6 is a block diagram illustrating an embodiment of the Ordering System 105 of the system. The Ordering System 105 includes an Ad Buyer Interface Generator 601 that presents ad inventory to the Ad Buyer depending on the Media Provider and type of media (TV, Radio, Print, Digital, and the like) that is selected by the Ad Buyer. The Ad Buyer Interface Generator 601 is coupled to an Ad Inventory Processor 602. The Ad Inventory Processor 602 is used to access Media Provider Inventory Database 603 and to normalize the inventory for consistent presentation to the Ad Buyer using the Ad Buyer Interface Generator 601.

The Media Provider Inventory Database 603 accesses individual Media Providers via a network such as Internet 604. The communication and access may be via wired or wireless communication as desired. As the Ad Buyer selects ad inventory using the Interface Generator 601, the system stores the ad unit data, scheduling of the ad unit and payment information, as well as Ad Buyer accounting in Schedule and Accounting block 605, which is in communication with the Ad Inventory Processor 602 and the Ad Buyer Interface Generator 601.

The Accounting block 605 interfaces with the station traffic systems and accounting systems of participating Media Providers 104 so that all bookkeeping and accounting functions can be automated using the system.

The Ordering System 105 provides integration with the Media Provider 104 traffic systems and accounting systems, as well as with the agency stewardship systems of the Media Buyer 101 and advertising agency directing the campaign. The system presents a consistent ad unit ordering interface that is then normalized or translated as necessary to interface with the system of the Media Provider 104. The Media Buyer 101 can purchase ad units from a plurality of Media Providers 104 using the Ordering System 105.

The Payment System 102 includes a Payment Portal 107 that communicates with the Ordering System 105. The Payment System 102 includes a Funds Transfer Module 108 that is in communication with the Buyer Bank 106 (of the Media Buyer 101) and Payment System Portal 107. A Payment System Bank 109 can direct fund transfers 108 between Media Buyer Bank 106 and Media Provider bank 116.

In one embodiment, the Media Provider 104 may utilize a media rep firm or Distributor 103 as an extension of the Media Provider's own sales team. The Distributor 103 would negotiate with the Media Buyer 101 to sell ad units from the Media Provider 104. It should be noted that in other embodiments, the Distributor 103 may not be utilized and the Media Buyer obtains commitments for ad units directly from the Media Provider 104 through the Ordering System 105.

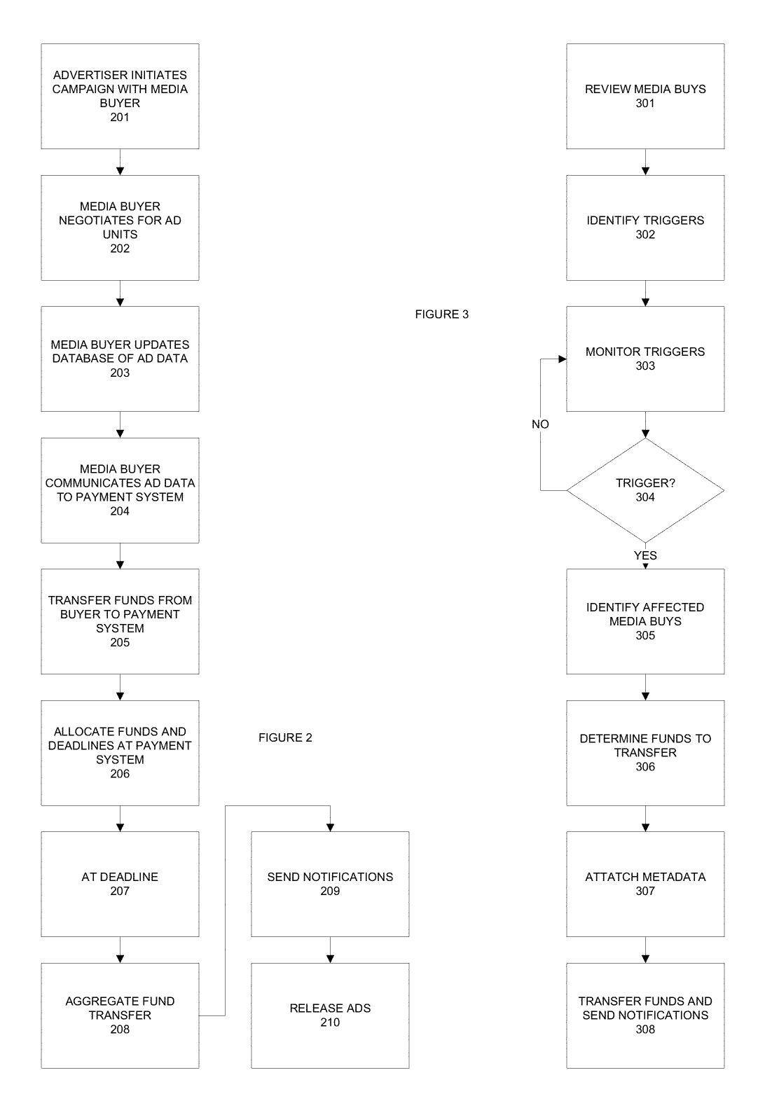

FIG. 2 is a flow diagram that illustrates the operation of the system in one embodiment. At step 201 an advertiser initiates an advertising campaign with a Media Buyer 101. The advertiser defines a media spend for the campaign and defines other goals and characteristics of the campaign. At this point, the advertiser typically transfers the gross payment for the overall media campaign to the Media Buyer 101.

At step 202 the Media Buyer negotiates for ad units with a Media Provider 104, either directly or via a Distributor 103. Either the Media Buyer 101, or the Distributor 103, can utilize the Ordering System 105 to initiate and confirm ad buys from the Media Providers 104. This negotiation includes the markets, programs, run dates, run times, pricing, and payment deadlines for each of the ad units. This information may be found in the Ordering System 104. The process can also use some combination of the Ordering System 104 and other channels of commerce for accumulating the ad buys as desired.

In one embodiment the Media Buyer 101 or Distributer 103 can negotiate the purchase of ad units outside of the system, and then transfer the entire campaign and all of the purchase of ad units into the system. The system includes a database of all of the deadlines, payees, routing numbers, deposit information and all other information used in effecting a fund transfer to each Media Provider. The System is able to associate the ad unit of a particular Media Provider to the rules of payment of that Media Provider, and ensure the system will automatically act when the deadline arrives.

For example, in political advertising, ad units may be purchased by the week from a Media Provider. The Media Provider may require that payment be received by close of business on the Friday preceding the week in which the ad units will be released. The system will use that as the deadline for the release of funds and the automatic sending of notifications to the Media Provider, so that the Media Buyer and Media Provider can be confident that conditions have been met for the ad unit to be released.

In return for the benefits of quick and reliable payment from the Media Buyer, the Media Provider may agree to a fee representing a percentage of the transferred funds to be paid to the system. When the campaign is transferred to the system, or when it is initiated through the system, an identifier unique to the campaign can be designated and associated with the campaign funds in the system bank.

It should be noted that the system is not limited to a single ad campaign. The Media Buyer 101 may negotiate ad times on behalf of a plurality of advertisers with a plurality of Media Providers 104. At step 203 the Media Buyer 101 updates its accounting system (e.g. through Ordering System 105) to include all outstanding media buys, rates, deadlines and other related information. In one embodiment, a Media Buyer 101 who utilizes the system may use the accounting system of the Ordering System for the ad campaign, or may use it as a parallel accounting system to their own.

At step 204, the Media Buyer 101 updates the portal 107 of Payment System 102 with the ad data of step 203 via the Ordering System 105. In one embodiment, the Ordering System 105 provides automatic updates to the portal 107 when a transaction is completed between a Media Buyer 101 and Media Provider 104.

At step 205 the Buyer transfers (108) the gross funds for the media buy from the Buyer Bank 106 to the Payment System Bank 107. The Payment System 102 allocates the appropriate funds for each Media Provider 104 along with related deadlines at step 206. This provides the advantage to the Media Buyer (and advertiser) of only dealing with a single payee (i.e. the system) for the entire ad campaign, regardless of who the Media Provider 104 is or where they Media Provider 104 may be located. The funds are in the system bank 107 and are ready to be remitted upon the occurrence of certain deadlines for the ad buys, set by the one or more Media Providers 104 involved in selling ad units for the campaign.

When a deadline for payment is reached at step 207, the Payment system initiates an aggregate fund transfer at step 208 for all ad units affected by the deadline, whether for a single advertiser for the Media Buyer 101 or for multiple advertisers for Media Buyer 101. In addition, funds are transferred to each Media Provider 104 that may be associated with a particular deadline for payment. The payments may be by wire transfer, electronic payment, or some other suitably fast system.

At step 209 notifications (111, 113, 114, 117) are sent to inform the participants of the payment. These notifications may be by email, text, telephone, or by any other appropriate means so that the Media Provider can feel confident in releasing and running all affected ads at step 210. The notification of remittance is essentially in real time, so that the Ad Buyer 101 can schedule the payments relatively close to the Media Provider 104 deadline without fearing that the remittance won't be acknowledged in enough time to run the ad unit.

It should be noted that notifications may be sent at multiple times that are customizable by the system on an advertiser by advertiser basis, as well as on a Media Provider by Media Provider basis. The timing and amount of notifications may be customized as appropriate.

The aggregate transfer at step 208 and the notifications at step 209 include all appropriate metadata so that the appropriate accounting and allocation can be made for each ad unit, each advertiser, and each media provider. Accounting systems of the Ad Buyer 101 and Media Provider 104 that are integrated with the system are updated automatically after each transaction. Once the notifications are received, the Media Provider 104 can release the ads and run them at step 210.

FIG. 3 is a flow diagram illustrating aggregate fund transfer in an embodiment of the system. At step 301 the system reviews all media buys residing in the payment system database 107. At step 302 the system identifies the appropriate triggers for each media buy and builds a trigger list. Typically the trigger list will comprise dates and times that are the deadlines for the release of funds, but other triggers may be used in the system as well. For example, a trigger may include a direct request, a manual request, or immediate request to issue payment from the Media Buyer 101 to the Media Provider 104

At step 303 the system monitors for triggers. At decision block 304 it is determined if a trigger has been detected. If not the system returns to step 303 to continue monitoring for triggers.

If a trigger is detected at step 304, the system proceeds to step 305 to identify all media buys that are associated with the trigger. As noted previously, the payment system can be used for one or multiple advertisers and for one or multiple Media Providers 104. At step 306 the system determines the amount of funds to be transferred and the destination of each transfer. At step 307 the system attaches the appropriate identifying metadata with each transfer so that appropriate allocation can be made. In one embodiment, the system may provide a spreadsheet of the proposed payments to the Media Buyer 101 for approval and confirmation. This may be via a web interface where the Media Buyer 101 can accept or reject each proposed payment as desired.

At step 308 the system executes the aggregate fund transfers that have been approved by the Media Buyer 101 and provides notifications to all interested parties that the payments have been made. This is accomplished by transferring funds from Buyer bank 106 via system bank 109 to Media Provider bank 116. At this point, ads can be released by the Media Provider 104.

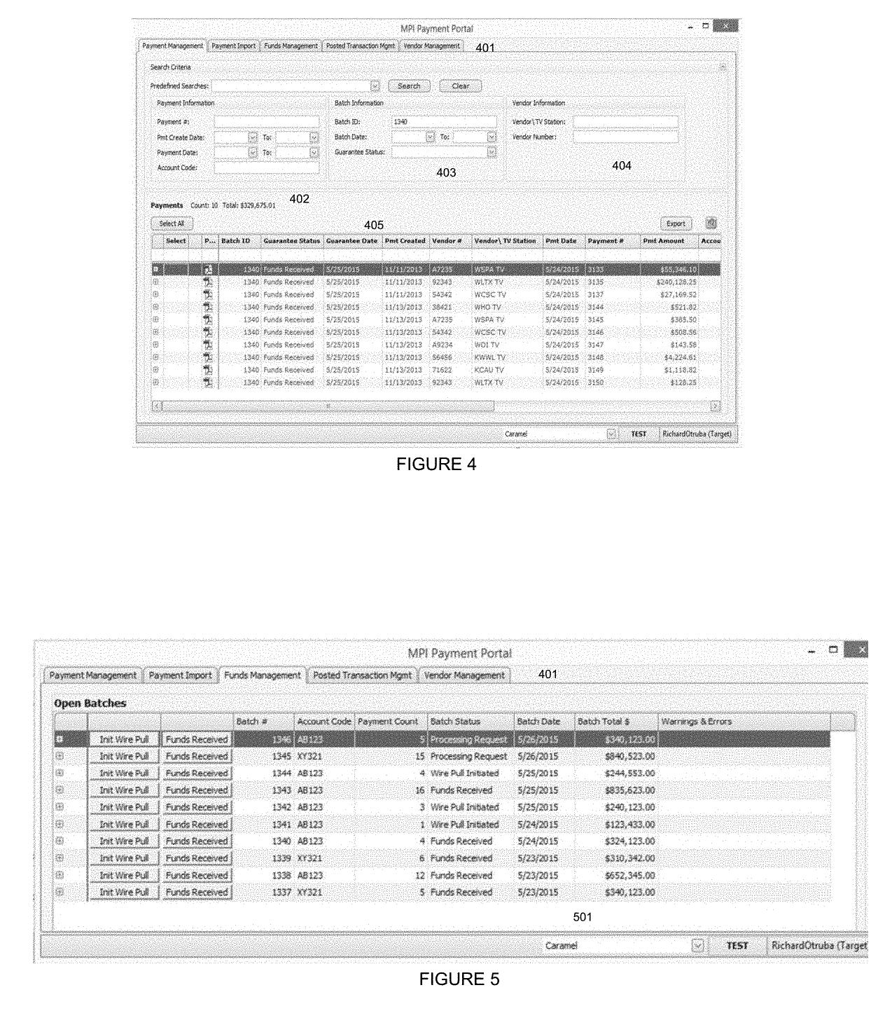

FIG. 4 is an example of an interface for a portal to be used by a Media Buyer 101. The portal allows the Buyer to identify the ad units that have been ordered, the associated deadlines, the media provider, payment amounts, payment status, and the like. The interface includes a number of tabs 401 that can be selected for different options. FIG. 4 illustrates the Payment Management tab, but in the embodiment the user can also select Payment Import, Funds Management, Posted Transaction Management, and Vendor Management.

Section 402 defines payment information, including payment number, create date, payment date, and account code. Section 403 defines Batch Information that can be used to combine payments into a single transaction as appropriate. Section 404 displays vendor information such as vendor/TV station, Vendor Number, and the like.

A section 405 shows a list of payments and includes pdfs of each payment, guarantee date, guarantee status, and the like.

FIG. 5 is an example of a portal of FIG. 4 illustrating the Funds Management Tab in section 401. This tab allows the management of funds for transfer, shows status of each batch, dates, total funds transferred and the like in section 501. In one embodiment of the system, a wire pull transaction is used as the fund transfer mechanism. However, other mechanisms may be used without departing from the scope and spirit of the system.

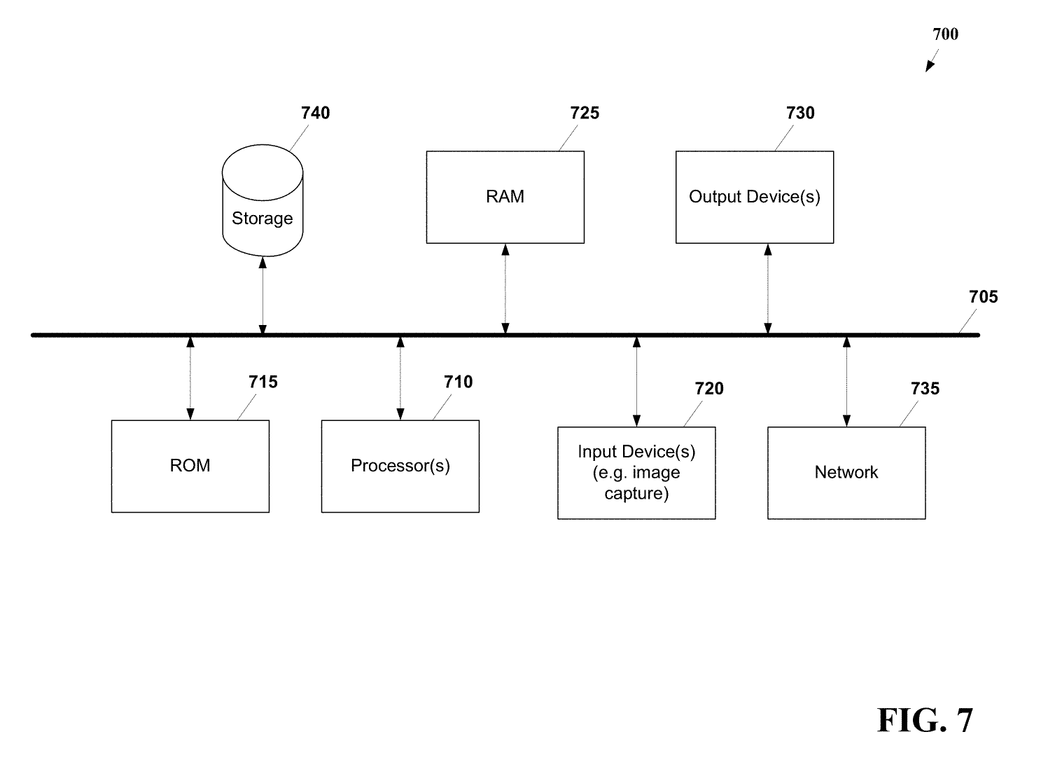

FIG. 7 illustrates an exemplary embodiment of a system 700 that may implement the license plate detection apparatus. The electronic system 700 of some embodiments may be a mobile apparatus. The electronic system includes various types of machine readable media and interfaces. The electronic system includes a bus 705, processor(s) 710, read only memory (ROM) 715, input device(s) 720, random access memory (RAM) 725, output device(s) 730, a network component 735, and a permanent storage device 740.

The bus 705 communicatively connects the internal devices and/or components of the electronic system. For instance, the bus 705 communicatively connects the processor(s) 710 with the ROM 715, the RAM 725, and the permanent storage 740. The processor(s) 710 retrieve instructions from the memory units to execute processes of the invention.

The processor(s) 710 may be implemented with one or more general-purpose and/or special-purpose processors. Examples include microprocessors, microcontrollers, DSP processors, and other circuitry that can execute software. Alternatively, or in addition to the one or more general-purpose and/or special-purpose processors, the processor may be implemented with dedicated hardware such as, by way of example, one or more FPGAs (Field Programmable Gate Array), PLDs (Programmable Logic Device), controllers, state machines, gated logic, discrete hardware components, or any other suitable circuitry, or any combination of circuits.

Many of the above-described features and applications are implemented as software processes of a computer programming product. The processes are specified as a set of instructions recorded on a machine readable storage medium (also referred to as machine readable medium). When these instructions are executed by one or more of the processor(s) 710, they cause the processor(s) 710 to perform the actions indicated in the instructions.

Furthermore, software shall be construed broadly to mean instructions, data, or any combination thereof, whether referred to as software, firmware, middleware, microcode, hardware description language, or otherwise. The software may be stored or transmitted over as one or more instructions or code on a machine-readable medium. Machine-readable media include both computer storage media and communication media including any medium that facilitates transfer of a computer program from one place to another. A storage medium may be any available medium that can be accessed by the processor(s) 710. By way of example, and not limitation, such machine-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a processor. Also, any connection is properly termed a machine-readable medium. For example, if the software is transmitted from a web site, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects machine-readable media may comprise non-transitory machine-readable media (e.g., tangible media). In addition, for other aspects machine-readable media may comprise transitory machine-readable media (e.g., a signal). Combinations of the above should also be included within the scope of machine-readable media.

Also, in some embodiments, multiple software inventions can be implemented as sub-parts of a larger program while remaining distinct software inventions. In some embodiments, multiple software inventions can also be implemented as separate programs. Any combination of separate programs that together implement a software invention described here is within the scope of the invention. In some embodiments, the software programs, when installed to operate on one or more electronic systems 700, define one or more specific machine implementations that execute and perform the operations of the software programs.

The ROM 715 stores static instructions needed by the processor(s) 710 and other components of the electronic system. The ROM may store the instructions necessary for the processor(s) 710 to execute the processes provided by the license plate detection apparatus. The permanent storage 740 is a non-volatile memory that stores instructions and data when the electronic system 700 is on or off. The permanent storage 740 is a read/write memory device, such as a hard disk or a flash drive. Storage media may be any available media that can be accessed by a computer. By way of example, the ROM could also be EEPROM, CD-ROM or other optical disk storage, magnetic disk storage or other magnetic storage devices, or any other medium that can be used to carry or store desired program code in the form of instructions or data structures and that can be accessed by a computer.

The RAM 725 is a volatile read/write memory. The RAM 725 stores instructions needed by the processor(s) 710 at runtime, the RAM 725 may also store the real-time video images acquired during the license plate detection process. The bus 705 also connects input and output devices 720 and 730. The input devices enable the user to communicate information and select commands to the electronic system. The input devices 720 may be a keypad, image capture apparatus, or a touch screen display capable of receiving touch interactions. The output device(s) 730 display images generated by the electronic system. The output devices may include printers or display devices such as monitors.

The bus 705 also couples the electronic system to a network 735. The electronic system may be part of a local area network (LAN), a wide area network (WAN), the Internet, or an Intranet by using a network interface. The electronic system may also be a mobile apparatus that is connected to a mobile data network supplied by a wireless carrier. Such networks may include 3G, HSPA, EVDO, and/or LTE.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other apparatuses, devices, or processes. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

Using this system, the payment of funds for media buys can be made more quickly, efficiently, and simply.

What is claimed is:

1. A method of scheduling and paying for ad units comprising:
using a processor implemented system:
scheduling a plurality of ad units associated with a media campaign, wherein the ad units are scheduled by a Media Buyer using an ordering system that provides ad inventory of a plurality of Media Providers;
for each ad unit, scheduling an air time for the ad unit and a deadline to pay a cost required to release the ad unit;
directing the Media Buyer to deposit into a system account associated with the processor implemented system the cost of each scheduled ad unit;
automatically transferring the cost for the ad unit when the deadline has occurred from the system account to a Media Provider account associated with the Media Provider providing the ad unit;
notifying a Media Provider that provides the ad unit that the cost has been transferred to the Media Provider account;
automatically providing an instruction to the Media Provider of the ad unit to release the ad unit for airing.

2. The method of claim 1 wherein the ordering system is coupled to accounting and scheduling systems of a plurality of Media Providers.

3. The method of claim 2 wherein the ordering system normalizes data from each Media Provider to present a consistent interface to the Media Buyer.

4. The method of claim 1 wherein the funds are transferred from the system account to the Media Provider account by wire transfer.

5. The method of claim 1 wherein the funds are transferred from the system account to the Media Provider account by electronic deposit.

6. The method of claim 1 wherein a notification is automatically generated to the Media Buyer and the Media Provider when the funds are transferred.

7. The method of claim 1 wherein accounting information about each transfer is automatically provide to the Media Buyer and the Media Provider.

8. The method of claim 1 wherein the ordering system comprises:
an Ad Buyer Interface Generator to generate an interface showing available ad unit inventory;
an Ad Inventory Processor coupled to the Ad Buyer Interface Generator and to a Media Provider Inventory Database to store available Ad Inventory to be scheduled in the system;
an Ad Buyer Scheduler and Accounting System to store each ad unit selected by the Ad Buyer.
